(19) United States
(12) Patent Application Publication
(10) Pub. No.: US 2010/0323932 A1
(43) Pub. Date: Dec. 23, 2010

(54) METHODS FOR TREATING A WELL OR THE LIKE

(76) Inventors: Oscar Bustos, Trophy Club, TX (US); Syed A. Ali, Sugar Land, TX (US); Mohan K.R. Panga, Stafford, TX (US)

Correspondence Address: SCHLUMBERGER TECHNOLOGY CORPORATION;David Cate, IP DEPT., WELL STIMULATION, 110 SCHLUMBERGER DRIVE, MD1, SUGAR LAND, TX, 77478, US

(21) Appl. No.: 12/789,577

(22) Filed: May 28, 2010

Related U.S. Application Data
(60) Provisional application No. 61/187,976, filed on Jun. 17, 2009.

(51) Int. Cl. C09K 8/64; C09K 8/44

(52) U.S. Cl. 507/219; 507/200; 507/203; 507/265; 523/130; 523/131

(57) ABSTRACT

A method is disclosed where introducing into a wellbore a degradable material stabilized in a non-aqueous based fluid.

### CROSS-REFERENCE TO RELATED APPLICATIONS

This application claims the benefit of U.S. Provisional Application No. 61/187,976, filed Jun. 17, 2009, which is incorporated herein by reference in its entirety.

### FIELD OF THE INVENTION

This invention relates generally to a method for controlling fluid loss. More specifically, the present invention relates to methods for controlling the loss of well treatment fluids, such as fluids used for stimulating production of hydrocarbons from such formations, fluids used for diverting the flow of fluids, fluids used for controlling water production, pad stages for conventional propped fracturing treatments, solvent treatments, and in general, any fluid used in treating a formation.

### BACKGROUND

Some statements may merely provide background information related to the present disclosure and may not constitute prior art.

In a wide range of well and formation treatment methods it is desirable to use various materials such as solids for downhole operations or procedures, and then later to remove or destroy the materials, after they have fulfilled their function, to restore properties to the wellbore and/or subterranean formations such as permeability for oil and gas production, or to activate the materials to fulfill a function such as a viscosity breaker or breaker aid.

Fluid loss control agents provide one example. When placing fluids in oilfield applications, fluid loss into the formation is a major concern. Fluid loss reduces the efficiency of the fluid placement with respect to time, fluid volume, and equipment. Thus, controlling fluid loss is highly desired. In the same way, there are many oilfield applications in which filter cakes are needed in the wellbore, in the near-wellbore region or in one or more strata of the formation. Such applications are those in which, without a filter cake, fluid would leak off into porous rock at an undesirable rate during a well treatment. Such applications include drilling, drill-in, completion, stimulation (for example, hydraulic fracturing or matrix dissolution), sand control (for example gravel packing, frac-packing, and sand consolidation), diversion, scale control, water control, and others. When the filter cake is within the formation it is typically called an “internal” filter cake; otherwise it is called an “external” filter cake. Typically, after these treatments have been completed the continued presence of the filter cake is undesirable or unacceptable.

Solid, substantially insoluble, or sparingly or slowly soluble materials (that may be called fluid loss additives and/or filter cake components) are typically added to conventional stimulation or completion fluids (hydraulic fracturing, gravel packing, or fracturing and gravel packing) to form filter cakes, although sometimes soluble (or at least highly dispersed) components of the fluids (such as polymers or crosslinked polymers) may form some or all of the filter cakes. Removal of the filter cake is typically accomplished either by a mechanical means (scraping, jetting, or the like), or by manipulation of the physical state of the filter cake, or dissolving at least a portion of the filter cake by addition of an agent (such as an acid, a base, an oxidizer, or an enzyme) that dissolves at least a portion of the filter cake, These removal methods usually require a tool or addition of another fluid (for example to change the pH or to add a chemical). This can sometimes be accomplished in the wellbore but normally cannot be done in a proppant or gravel pack. Sometimes the operator may rely on the flow of produced fluids (which will be in the opposite direction from the flow of the fluid when the filter cake was laid down) to loosen the filter cake or to dissolve at least a part of the filter cake (for example if it is a soluble salt). However, these methods require fluid flow and often result in slow or incomplete filter cake removal. Sometimes a breaker can be incorporated in the filter cake but these must normally be delayed (for example by esterification or encapsulation) and they are often expensive and/or difficult to place and/or difficult to trigger.

The use of a hydrolysable polyester material for use as a fluid loss additive for fluid loss control has previously been proposed for polymer-viscosified fracturing fluids. After the treatment, the fluid loss additive degrades and so contributes little damage. Further, degradation products of such materials have been shown to cause delayed breaking of polymer-viscosified fracturing fluids. U.S. Pat. No. 4,715,967 discloses the use of polyglycolic acid (PGA) as a fluid loss additive to temporarily reduce the permeability of a formation and is incorporated by reference herein. U.S. Pat. No. 6,509,301 describes the use of acid forming compounds such as PGA as delayed breakers of surfactant-based fluids and is incorporated by reference herein. The preferred pH of these materials is above 6.5, more preferably between 7.5 and 9.

Since VES fluid systems cause negligible damage, it is desirable to use a fluid loss additive that is compatible with the VES system and also causes negligible damage. The use of polylactic acid (PLA), polyglycolic acid and similar materials as a fluid loss additive for VES fluid systems is described in U.S. Pat. No. 7,219,731 which is incorporated by reference herein.

Also, for years fibers have been used for different purposes in oilfield treatment operations. Most recently, fiber assisted transport technology has been used to improve particle transport in fracturing and wellbore cleanout operations while reducing the amount of other fluid viscosifiers required. Recent efforts to improve this technique have looked at better ways to more completely remove fiber that can be left in the wellbore or fracture.

In U.S. Pat. No. 7,275,596 which is incorporated by reference herein, polyester materials such as fibers and particles are disclosed for fiber assisted transport of proppant in a fracturing method and for fluid loss control. The polyesters can be selected from substituted and unsubstituted lactide, glycolide, polylactic acid, polyglycolic acid, copolymers of polylactic acid and polyglycolic acid, copolymers of glycolic acid with other hydroxy-, carboxylic acid-, or hydroxycarboxylic acid-containing moieties, and copolymers of lactic acid with other hydroxy-, carboxylic acid-, or hydroxycarboxylic acid-containing moieties, and mixtures of those materials. The polyester materials are naturally degraded typically 4 hours to 100 days after treatment to facilitate the restoration of permeability. As well U.S. Patent Applications Publication No. 20080139417 and No. 20080139416 which are incorporated by reference herein, relate to methods to reduce fluid loss by using degradable particles.

There is a need for alternate methods of using degradable particles or fibers with non-aqueous solvent, especially as fluid loss control agent to restore permeability to the producing formation.

### SUMMARY

In a first aspect, a method comprising introducing into a well a non-aqueous based fluid comprising a degradable material stabilized therein is disclosed.

In a second aspect, a method to reduce fluid loss is disclosed. The method comprises introducing in a wellbore intersecting a subterranean formation a degradable material stabilized in a non-aqueous based fluid, contacting the material with the formation, and reducing fluid loss into the formation.

The degradable material may comprise at least one of lactide, glycolide, polylactic acid, polyglycolic acid, copolymers of polylactic acid and polyglycolic acid, copolymers of glycolic acid with other hydroxy-, carboxylic acid-, or hydroxycarboxylic acid-containing moieties, copolymers of lactic acid with other hydroxy-, carboxylic acid-, or hydroxycarboxylic acid-containing moieties, or mixtures thereof.

The non-aqueous based fluid may comprise an organic solvent, which may be selected from the group consisting of diesel oil, kerosene, paraffinic oil, crude oil, LPG, toluene, xylene, ether, ester, mineral oil, biodiesel, vegetable oil, animal oil, and mixtures thereof.

### BRIEF DESCRIPTION OF THE DRAWINGS

FIG. 1 shows fiber decomposition time versus temperature for mixtures of PLA fibers and air, diesel or mineral oil.

FIG. 2 shows fiber decomposition time versus temperature for mixtures of PLA fibers and air, diesel or mineral oil for different concentrations in HCl acid.

FIG. 3 shows fiber dissolution overtime for PLA fibers.

FIG. 4 shows 1% wt PLA fibers with or without dibutyl ether acting as fluid loss agent.

FIG. 5 shows 10% wt PLA fibers with or without dibutyl ether acting as fluid loss agent.

### DETAILED DESCRIPTION

At the outset, it should be noted that in the development of any such actual embodiment, numerous implementation-specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. The description and examples are presented solely for the purpose of illustrating the preferred embodiments of the invention and should not be construed as a limitation to the scope and applicability of the invention. While the compositions of the present invention are described herein as comprising certain materials, it should be understood that the composition could optionally comprise two or more chemically different materials. In addition, the composition can also comprise some components other than the ones already cited.

In the summary of the invention and this description, each numerical value should be read once as modified by the term “about” (unless already expressly so modified), and then read again as not so modified unless otherwise indicated in context. Also, in the summary of the invention and this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific data points, it is to be understood that inventors appreciate and understand that any and all data points within the range are to be considered to have been specified, and that inventors have disclosed and enabled the entire range and all points within the range.

According to embodiments of the invention degradable fibers or particles made of degradable polymers are used. The differing molecular structures of the degradable materials that are suitable for the present invention give a wide range of possibilities regarding regulating the degradation rate of the degradable material. The degradability of a polymer depends at least in part on its backbone structure. One of the more common structural characteristics is the presence of hydrolyzable and/or oxidizable linkages in the backbone. The rates of degradation of, for example, polyesters, are dependent on the type of repeat unit, composition, sequence, length, molecular geometry, molecular weight, morphology (e.g., crystallinity, size of spherulites, and orientation), hydrophilicity, surface area, and additives. Also, the environment to which the polymer is subjected may affect how the polymer degrades, e.g., temperature, presence of moisture, oxygen, microorganisms, enzymes, pH, and the like. One of ordinary skill in the art, with the benefit of this disclosure, will be able to determine what the optimum polymer would be for a given application considering the characteristics of the polymer utilized and the environment to which it will be subjected.

Suitable examples of polymers that may be used in accordance with the present invention include, but are not limited to, homopolymers, random aliphatic polyester copolymers, block aliphatic polyester copolymers, star aliphatic polyester copolymers, or hyperbranched aliphatic polyester copolymers. Such suitable polymers may be prepared by polycondensation reactions, ring-opening polymerizations, free radical polymerizations, anionic polymerizations, carbocationic polymerizations, coordinative ring-opening polymerization for, such as, lactones, and any other suitable process. Specific examples of suitable polymers include polysaccharides such as dextran or cellulose; chitins; chitosans; proteins; aliphatic polyesters; poly(lactides); poly(glycolides); poly(ε-caprolactones); poly(hydroxy ester ethers); poly(hydroxybutyrates); polyanhydrides; polycarbonates; poly(orthoesters); poly(acetals); poly(acrylates); poly(alkylacrylates); poly(amino acids); poly(ethylene oxide); poly ether esters; polyester amides; polyamides; polyphosphazenes; and copolymers or blends thereof. Other degradable polymers that are subject to hydrolytic degradation also may be suitable. Of these suitable polymers, aliphatic polyesters are preferred. Of the suitable aliphatic polyesters, polyesters of α or β hydroxy acids are preferred. Poly(lactide) is most preferred. Poly(lactide) is synthesized either from lactic acid by a condensation reaction or more commonly by ring-opening polymerization of cyclic lactide monomer. The lactide monomer exists generally in three different forms: two stereoisomers L- and D-lactide; and D,L-lactide (meso-lactide). The chirality of the lactide units provides a means to adjust, inter alia, degradation rates, as well as the physical and mechanical properties after the lactide is polymerized. Poly(L-lactide), for instance, is a semicrystalline polymer with a relatively slow hydrolysis rate. This could be desirable in applications of the present invention where slow degradation of the degradable material is desired. Poly(D,L-lactide) is an amorphous polymer with a much faster hydrolysis rate. This may be suitable for other applications of the methods and compositions of the present invention. The stereoisomers of lactic acid may be used individually or combined for use in the compositions and methods of the present invention. Additionally, they may be copolymerized with, for example, glycolide or other monomers like ε-caprolactone, 1,5-dioxepan-2-one, trimethylene carbonate, or other suitable monomers to obtain polymers with different properties or degradation times. Additionally, the lactic acid stereoisomers can be modified by blending high and low molecular weight polylactide or by blending polylactide with other aliphatic polyesters. For example, the degradation rate of polylactic acid may be affected by blending, for example, high and low molecular weight polylactides; mixtures of polylactide and lactide monomer; or by blending polylactide with other aliphatic polyesters.

One guideline for choosing which composite particles to use in a particular application is what degradation products will result. Another guideline is the conditions surrounding a particular application. In choosing the appropriate degradable material, one should consider the degradation products that will result. For instance, some may form an acid upon degradation, and the presence of the acid may be undesirable; others may form degradation products that would be insoluble, and these may be undesirable. Moreover, these degradation products should not adversely affect other operations or components.

The physical properties of degradable polymers may depend on several factors such as the composition of the repeat units, flexibility of the chain, presence of polar groups, molecular mass, degree of branching, crystallinity, orientation, etc. For example, short chain branches reduce the degree of crystallinity of polymers while long chain branches lower the melt viscosity and impart, inter alia, extensional viscosity with tension-stiffening behavior. The properties of the material utilized can be further tailored by blending, and copolymerizing it with another polymer, or by a change in the macromolecular architecture (e.g., hyper-branched polymers, star-shaped, or dendrimers, etc.). The properties of any such suitable degradable polymers (such as hydrophilicity, rate of biodegration, etc.) can be tailored by introducing functional groups along the polymer chains. One of ordinary skill in the art, with the benefit of this disclosure, will be able to determine the appropriate functional groups to introduce to the polymer chains to achieve the desired effect.

In an embodiment, the polyester material degrades after temporarily sealing for fluid loss during the treatment operation, and helps restore permeability and conductivity for reservoir fluid production. The delayed degradation of polyester generally includes hydrolysis of the ester moieties at downhole conditions of elevated temperature and an aqueous environment into hydrolysis such as carboxylic acid and hydroxyl moieties, for example. The hydrolysis in one embodiment can render the polyester filtercake degradation products entirely soluble in the downhole and/or reservoir fluids. In an alternative or additional embodiment, the entire filtercake need not be entirely soluble following polyester degradation; it is sufficient only that enough hydrolysis occurs so as to allow the residue of the degraded or partially degraded filter cake to be lifted off of the sealed surface by a low backflow pressure from produced reservoir fluids.

The above mentioned degradable materials in one embodiment are comprised solely of polyester particles, e.g., the system can be free or essentially free of non-polyester solids. In another embodiment, the polyester can be mixed or blended with other degradable or dissolvable solids, for example, solids that react with the hydrolysis products, such as magnesium hydroxide, magnesium carbonate, dolomite (magnesium calcium carbonate), calcium carbonate, aluminum hydroxide, calcium oxalate, calcium phosphate, aluminum metaphosphate, sodium zinc potassium polyphosphate glass, and sodium calcium magnesium polyphosphate glass, for the purpose of increasing the rate of dissolution and hydrolysis of the degradable material, or for the purpose of providing a supplemental bridging agent that is dissolved by the hydrolysis products. Moreover, examples of reactive solids that can be mixed include ground quartz (or silica flour), oil soluble resins, degradable rock salts, clays such as kaolinite, illite, chlorite, bentonite, or montmorillonite, zeolites such as chabazite, clinoptilolite, heulandite, or any synthetically available zeolite, or mixtures thereof. Degradable materials can also include waxes, oil soluble resins, and other materials that degrade or become soluble when contacted with hydrocarbons.

In embodiments of the invention, the particles of hydrolyzable material, optionally mixed with solid acid-reactive materials in the same or separate particles, are in the form of beads, powder, spheres, ribbons, platelets, fibers, flakes, or any other shape with an aspect ratio equal to or greater than one. In embodiments, the solids include particles having an aspect ratio greater than 10, greater than 100, greater than 200, greater than 250 or the like, such as platelets or fibers or the like. The blended materials can take any form of composites, for example biodegradable material coatings or scaffolds with other materials dispersed therein. Further, the degradable particles can be nano-, micro-, or mesoporous structures that are fractal or non-fractal.

According to embodiments of the invention, the degradable material is stabilized in a non-aqueous based fluid. The carrier fluid may be an organic solvent. The organic solvent may be selected from the group consisting of diesel oil, kerosene, paraffinic oil, crude oil, LPG, toluene, xylene, ether, ester, mineral oil, biodiesel, vegetable oil, animal oil, and mixtures thereof. Specific examples of suitable organic solvent include acetone, acetonitrile, benzene, 1-butanol, 2-butanol, 2-butanone, t-butyl alcohol, carbon tetrachloride, chlorobenzene, chloroform, cyclohexane, 1,2-dichloroethane, diethyl ether, diethylene glycol, diglyme (diethylene glycol dimethyl ether), 1,2-dimethoxy-ethane (glyme, DME), dimethylether, dibuthylether, dimethyl-formamide (DMF), dimethyl sulfoxide (DMSO), dioxane, ethanol, ethyl acetate, ethylene glycol, glycerin, heptanes, Hexamethylphosphoramide (HMPA), Hexamethylphosphorous triamide (HMPT), hexane, methanol, methyl t-butyl ether (MTBE), methylene chloride, N-methyl-2-pyrrolidinone (NMP), nitromethan, pentane, Petroleum ether (ligroine), 1-propanol, 2-propanol, pyridine, tetrahydrofuran (THF), toluene, triethyl amine, o-xylene, m-xylene, p-xylene.

Further solvents include aromatic petroleum cuts, terpenes, mono-, di- and tri-glycerides of saturated or unsaturated fatty acids including natural and synthetic triglycerides, aliphatic esters such as methyl esters of a mixture of acetic, succinic and glutaric acids, aliphatic ethers of glycols such as ethylene glycol monobutyl ether, minerals oils such as vaseline oil, chlorinated solvents like 1,1,1-trichloroethane, perchloroethylene and methylene chloride, deodorized kerosene, solvent naphtha, paraffins (including linear paraffins), isoparaffins, olefins (especially linear olefins) and aliphatic or aromatic hydrocarbons (such as toluene). Terpenes are preferred, especially d-limonene (most preferred), 1-limonene, dipentene (also known as 1-methyl-4-(1-methylethenyl)-cyclohexene), myrcene, alpha-pinene, linalool and mixtures thereof.

Further exemplary organic liquids include long chain alcohols (monoalcohols and glycols), esters, ketones (including diketones and polyketones), nitrites, amides, amines, cyclic ethers, linear and branched ethers, glycol ethers (such as ethylene glycol monobutyl ether), polyglycol ethers, pyrrolidones like N-(alkyl or cycloalkyl)-2-pyrrolidones, N-alkyl piperidones, N,N-dialkyl alkanolamides, N,N,N′,N′-tetra alkyl ureas, dialkylsulfoxides, pyridines, hexaalkylphosphoric triamides, 1,3-dimethyl-2-imidazolidinone, nitroalkanes, nitro-compounds of aromatic hydrocarbons, sulfolanes, butyrolactones, and alkylene or alkyl carbonates. These include polyalkylene glycols, polyalkylene glycol ethers like mono (alkyl or aryl)ethers of glycols, mono (alkyl or aryl)ethers of polyalkylene glycols and poly (alkyl and/or aryl)ethers of polyalkylene glycols, monoalkanoate esters of glycols, monoalkanoate esters of polyalkylene glycols, polyalkylene glycol esters like poly (alkyl and/or aryl) esters of polyalkylene glycols, dialkyl ethers of polyalkylene glycols, dialkanoate esters of polyalkylene glycols, N-(alkyl or cycloalkyl)-2-pyrrolidones, pyridine and alkylpyridines, diethylether, dimethoxyethane, methyl formate, ethyl formate, methyl propionate, acetonitrile, benzonitrile, dimethylformamide, N-methylpyrrolidone, ethylene carbonate, dimethyl carbonate, propylene carbonate, diethyl carbonate, ethylmethyl carbonate, and dibutyl carbonate, lactones, nitromethane, and nitrobenzene sulfones. The organic liquid may also be selected from the group consisting of tetrahydrofuran, dioxane, dioxolane, methyltetrahydrofuran, dimethylsulfone, tetramethylene sulfone and thiophen.

According to some embodiments, the non-aqueous based fluid is oil based fluid, for example conventional gelled oils used for fracturing operations. The non-aqueous based fluid may be a solvent as used for organic deposit removal, e.g. among the organic solvents cited above xylene, toluene or terpenes are used.

In embodiments of the invention, the non-aqueous based fluid further comprises water. The water amount may between 0.1% wt and 40% wt of the total amount of fluid. The water amount may between 1% wt and 30% wt of the total amount of fluid. The water amount may between 5% wt and 20% wt of the total amount of fluid.

According to some embodiments, the non-aqueous based fluid is an emulsion. The emulsion can be an oil-in-water emulsion. For example, the emulsion can be a water external emulsion, termed “polyemulsion”, where viscosified water is the continuous phase and oil is the discontinuous phase.

As well, the emulsion can be a water-in-oil emulsion. The water-in-oil emulsion consists of an outer (or continuous) hydrophobic phase which is particularly useful in dissolving oil residues and can be specially formulated to be biodegradable. In an embodiment, the external phase is a hydrophobic organic solvent as disclosed above. Mixtures of organic solvents may also be used. The internal (or discontinuous) phase of the water-in-oil emulsion is water, to which may be added any conventional additive used to treat unwanted particulates. The aqueous internal phase may be an aqueous salt solution such as sodium formate brine, potassium formate brine, cesium formate brine, sodium bromide brine, potassium bromide brine, calcium bromide brine, zinc bromide brine, cesium bromide brine, calcium chloride brine, sodium chloride brine, potassium chloride brine, cesium chloride brine, seawater and mixtures thereof. The use of such salts may be used to increase the density of the water-in-oil emulsion in those situations where higher density is sought at the interface.

According to some embodiments, the non-aqueous based fluid is an acid-in-oil emulsion. In an embodiment, the external phase is a hydrophobic organic solvent as disclosed above. Mixtures of organic solvents may also be used. The internal (or discontinuous) phase of the acid-in-oil emulsion is an aqueous acid. Examples of suitable aqueous acid solutions are aqueous solutions of acetic acid, formic acid, hydrochloric acid or mixtures of such acids. While the aqueous acid solution can be of any desired concentration, it generally has a concentration in the range of from about 1% to about 38% by weight of the solution. The aqueous acid solution can also contain one or more additives such as metal corrosion inhibitors, etc.

The emulsion may be formed by conventional methods, such as with the use of a homogenizer, with the application of shear. Mixing water with the organic solvent minimizes the expense of producing the emulsion. The amount of water which may be added to the organic solvent is an amount that will maintain the hydrophobicity of the organic solvent. Typically the amount of water forming the water-in-oil emulsion is between from about 10 to about 90, preferably between from about 20 to about 80, volume percent. In one embodiment, the water is present in the emulsion in an amount between from about 25 to about 35, typically around 28, volume percent. The water typically increases the viscosity of the emulsion, rendering a higher carrying capacity for removed solids.

Degradable materials stabilized with non-aqueous solvent are particularly useful in applications such as fluid loss treatment. The system of the invention may be used in combination with other components for other type of application, for example stimulation treatment as acidizing, fracturing, gravel packing.

In embodiments of the invention, systems of the invention made of degradable polymers are especially useful in conjunction with viscoelastic surfactant (VES) fluid system. VES fluid system is a fluid viscosified with a viscoelastic surfactant and any additional materials, such as but not limited to salts, co-surfactants, rheology enhancers, stabilizers and shear recovery enhancers that improve or modify the performance of the viscoelastic surfactant.

The useful VES's include cationic, anionic, nonionic, mixed, zwitterionic and amphoteric surfactants, especially betaine zwitterionic viscoelastic surfactant fluid systems or amidoamine oxide viscoelastic surfactant fluid systems. Examples of suitable VES systems include those described in U.S. Pat. Nos. 5,551,516; 5,964,295; 5,979,555; 5,979,557; 6,140,277; 6,258,859 and 6,509,301, which are all hereby incorporated by reference. The system of the invention is also useful when used with several types of zwitterionic surfactants. In general, suitable zwitterionic surfactants have the formula:

RCONH—(CH₂)ₐ(CH₂CH₂O)ₘ(CH₂)_{b}—N⁺(CH₃)₂—(CH₂)_{a′}(CH₂CH₂O)_{m′}(CH₂)_{b′}COO⁻

in which R is an alkyl group that contains from about 14 to about 23 carbon atoms which may be branched or straight chained and which may be saturated or unsaturated; a, b, a′, and b′ are each from 0 to 10 and m and m′ are each from 0 to 13; a and b are each 1 or 2 if m is not 0 and (a+b) is from 2 to about 10 if m is 0; a′ and b′ are each 1 or 2 when m′ is not 0 and (a′+b′) is from 1 to about 5 if m is 0; (m+m′) is from 0 to about 14; and the O in either or both CH₂CH₂O groups or chains, if present, may be located on the end towards or away from the quaternary nitrogen. Preferred surfactants are betaines.

Although the invention has been described using the term “VES”, or “viscoelastic surfactant” to describe the non-polymeric viscosified well treatment fluids, other non-polymeric materials may also be used to viscosify the fluid provided that the requirements described herein for such a fluid are met, for example the required viscosity, stability, compatibility, and lack of damage to the wellbore, formation or fracture face.

Friction reducers may also be incorporated into fluids used in the invention. Any friction reducer may be used, e.g. hydroxyethyl cellulose (HEC), xanthan, 2-acrylamido-2-methylpropanesulfonic acid (AMPS), sphingans such as diutan and the like. Also, polymers such as polyacrylamide, polyisobutyl methacrylate, polymethyl methacrylate and polyisobutylene as well as water-soluble friction reducers such as guar gum, guar gum derivatives, hydrolyzed polyacrylamide, and polyethylene oxide may be used. Commercial drag reducing chemicals such as those sold by Conoco Inc. under the trademark CDR as described in U.S. Pat. No. 3,692,676 (Culter et al.) or drag reducers such as those sold by Chemlink designated under the trademarks FLO 1003 (Trade Mark), 1004 (Trade Mark), 1005 (Trade Mark) & 1008 (Trade Mark) have also been found to be effective. These polymeric species added as friction reducers or viscosity index improvers may also act as fluid loss additives reducing or even eliminating the need for conventional fluid loss additives.

When system of the invention is used in fluids in such treatments as drilling, drill-in, completion, stimulation (for example, hydraulic fracturing or matrix dissolution), sand control (for example gravel packing, frac-packing, and consolidation), diversion, and others, the degradable particles or fibers are generally inert to the other components of the fluids, so the other fluids may otherwise be prepared and used in the usual way, taking care to avoid conditions that would tend to prematurely hydrolyze the particles or fibers.

Any additives normally used in such treatments may be included, again provided that they are compatible with the other components and the desired results of the treatment. Such additives may include, but are not limited to anti-oxidants, crosslinkers, corrosion inhibitors, delay agents, biocides, buffers, fluid loss additives, etc. The wellbores treated may be vertical, deviated or horizontal. They may be completed with casing and perforations or open hole.

In gravel packing, or combined fracturing and gravel packing, it is within the scope of the invention to apply the fluids and methods to treatments that are done with or without a screen. Although we have described the invention in terms of hydrocarbon production, it is within the scope of the invention to use the fluids and methods in wells intended for the production of other fluids such as carbon dioxide, water or brine, or in injection wells. Also it important to note that invention can be used as well, on injectors wells, where fluids like water, gas or carbon dioxide fluids are injected into a subterranean formation. Although we have described the invention in terms of unfoamed fluids, fluids foamed or energized (for example with nitrogen or carbon dioxide or mixtures of those gases) may be used. Adjustment of the appropriate concentrations due to any changes in the fluid properties or proppant concentration consequent to foaming would be made.

Any proppant (gravel) can be used, provided that it is compatible with the degradable materials, the formation, the carrier fluid, and the desired results of the treatment. Such proppants (gravels) can be natural or synthetic (including but not limited to glass beads, ceramic beads, sand, and bauxite), coated, or contain chemicals; more than one can be used sequentially or in mixtures of different sizes or different materials. The proppant may be resin coated, provided that the resin and any other chemicals in the coating are compatible with the other chemicals of embodiments of the invention, particularly the components of the viscoelastic surfactant fluid micelles. Proppants and gravels in the same or different wells or treatments can be the same material and/or the same size as one another and the term “proppant” is intended to include gravel in this discussion. In general the proppant used will have an average particle size of from about 0.15 mm to about 2.39 mm (about 8 to about 100 U.S. mesh), more particularly, but not limited to 0.25 to 0.43 mm (40/60 mesh), 0.43 to 0.84 mm (20/40 mesh), 0.84 to 1.19 mm (16/20), 0.84 to 1.68 mm (12/20 mesh) and 0.84 to 2.39 mm (8/20 mesh) sized materials. Normally the proppant will be present in the slurry in a concentration of from about 0.12 to about 3 kg/L, preferably about 0.12 to about 1.44 kg/L (about 1 PPA to about 25 PPA, preferably from about 1 to about 12 PPA). (PPA is “pounds proppant added” per gallon of liquid.)

Some embodiments of the invention relate to temporarily blocking of already-created fractures so that other zones may be fractured. As applied to multi-stage fracturing, at the tail end of a fracturing treatment, the fluid of the invention made of degradable material is pumped to temporarily plug a completed fracture. The temporary plug locks the proppants in a fracture, making them immobile and causing substantial stress increase and diversion in lower zones by means of a significant net pressure increase due to the high likelihood of proppant bridging with the degradable materials. In accordance with an alternative method of the invention, a degradable material can temporarily seal the perforations or fracture. In another alternative, the plug is formed in the wellbore to seal the perforations leading to the fracture. In yet another embodiment, a plug is formed in more than one of these locations. With this system, the fracture is protected and successive fracturing treatments, usually further up the hole, can be performed without the need for wireline intervention. The degradable material will dissolve with time and unplug the fracture. The degradable material may be of various properties, shapes and contents. The material decay or disintegration may be chemically, temperature or mechanically driven. These methods may be performed with any suitable equipment known in the art, including coiled tubing (CT) that has been installed in the wells for jetting new perforations.

Some embodiments of the invention relate to temporarily blocking of already-created fractures so that other zones may be stimulated, especially in matrix stimulation. The fluid of the invention made of degradable material is pumped to temporarily plug a near-wellbore reservoir formation zone. Accordingly, multi-stage matrix stimulation is realized by further injecting acid or treatment fluids into the formation at pressures below the fracturing pressure. Diverted thanks to the temporary plug, the fluids improve the production or injection flow capacity of zones of the well, which first would not be impacted by matrix stimulation.

Some embodiments of the invention relate to the use of the fluid of the invention made of degradable material as sealers or plugs to temporarily block perforations, fractures, or parts of the wellbore such that other operations may be performed without interference from or damage to the existing perforations, fractures or parts of the wellbores. The temporary sealer may be used to create zonal isolation as well. In accordance with an alternative method of the invention, a degradable material that can create a temporary sealer is pumped in the wellbore to temporarily seal the fracture or the perforation. In another alternative, the plug is formed in the wellbore to seal a lower part of the wellbore. In yet another embodiment, a plug is formed in more than one of these locations. With this system, part of the wellbore, fracture or perforation is protected and successive treatments, usually further up the hole, can be performed without the need for wireline intervention. For example, the sealer may be used as replacement of mechanical isolation between stimulation stages i.e. similar to a bridge plug. The degradable material will dissolve with time and unplug the fracture. The degradable material may be of various properties, shapes and contents. The material decay or disintegration may be chemically, temperature or mechanically driven. These methods may be performed with any suitable equipment known in the art, including coiled tubing (CT) that has been installed in the wells for jetting new perforations.

### EXAMPLES

Temperature: tests were conducted at room temperature when not specified or at 65, 75, 85, 95, 105 or 115° C. The fluid was heated to this temperature for 1 hour.

### Example 1

### PLA Fibers in Diesel or Mineral Oil

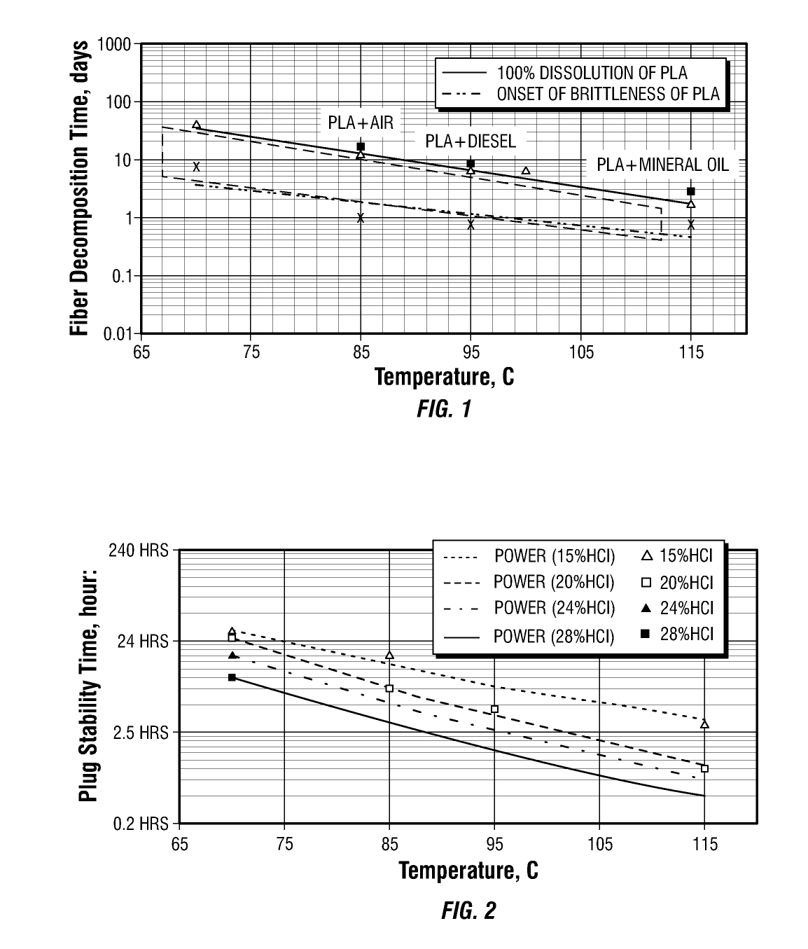

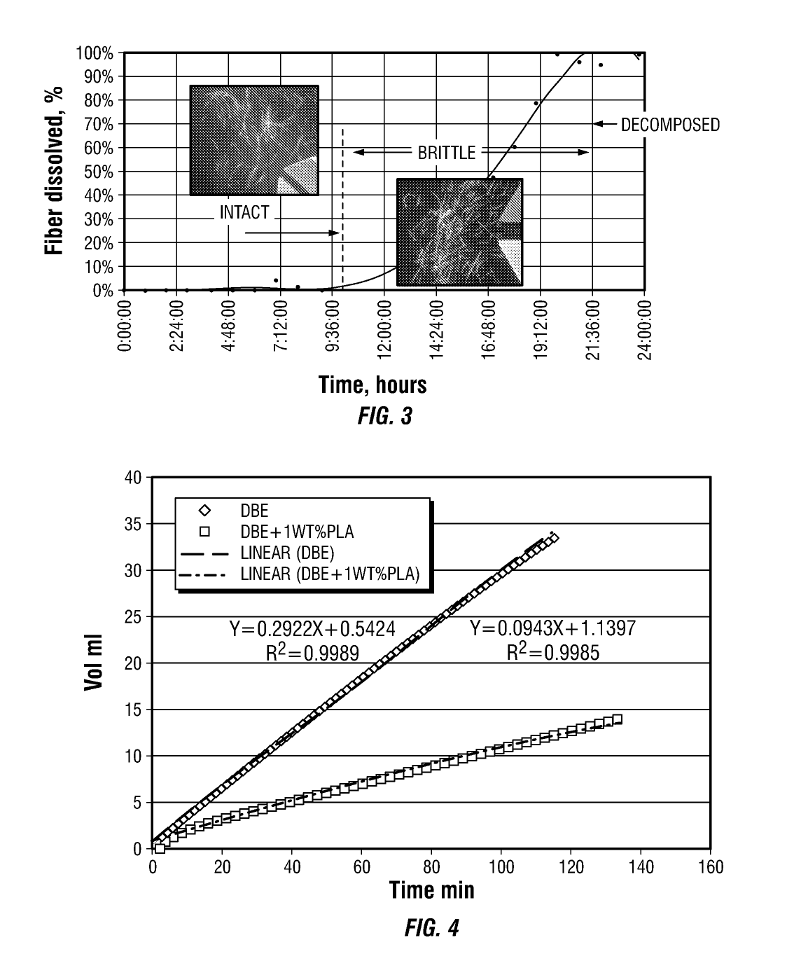

Stability of PLA fibers in two non-aqueous medium were tested. FIG. 1 shows results of the tests. PLA fibers in diesel are stable and onset of brittleness can be observed at 95° C. at 1 day. Total decomposition of the PLA fibers in diesel is observed after 9 days. PLA fibers in mineral oil are stable and onset of brittleness can be observed at 115° C. after 19 hours. Total decomposition of the PLA fibers in mineral oil is observed after 2 days. PLA fibers are stable in non aqueous solvents. FIG. 2 shows impact of acid concentration on decomposition of PLA fibers. FIG. 3 shows aspect of PLA fibers during brittle stage.

### Example 2

### 1% wt PLA Fibers in Dibuthyl Ether

Test was realized to show impact of non-aqueous media on fluid loss properties of PLA fibers at room temperature. The solvent is dibuthyl ether (DBE) a core saturated with brine was used. Initial permeability is 0.196 mD, diameter is 0.97 inch; length is 0.996 inch, area is 4.77 cm². The solvent viscosity was 2.6 cp. FIG. 4 shows under first curve (higher) displacement of solvent alone through the core and under second curve (lower) displacement of solvent with 1% wt PLA through the core. PLA is acting as fluid loss agent with non aqueous solvent.

### Example 3

### 10% wt PLA Fibers in Dibuthyl Ether

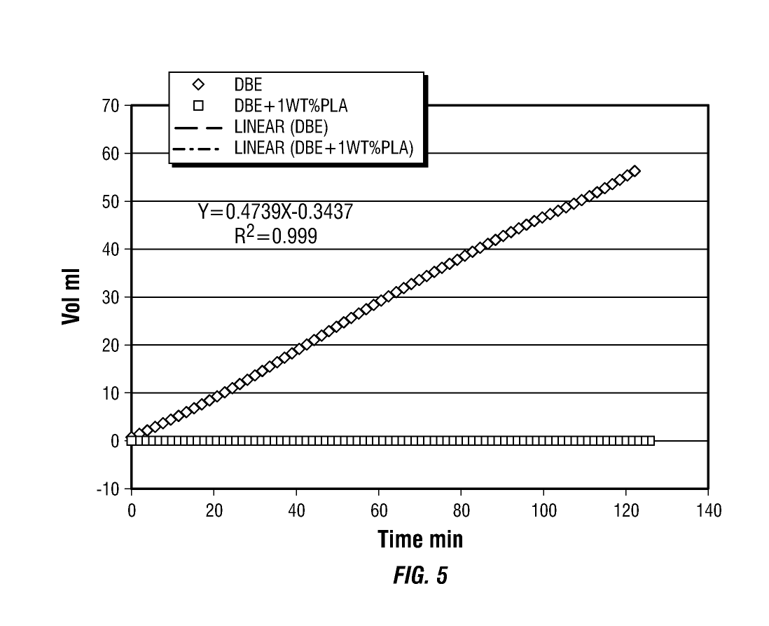

Test was realized to show impact of non-aqueous media on fluid loss properties of PLA fibers at room temperature. The solvent is still dibuthyl ether (DBE) a core saturated with brine was used. Initial permeability is 0.179 mD, diameter is 0.971 inch; length is 0.983 inch, area is 4.78 cm². The solvent viscosity was measured and is 2.6 cp. FIG. 5 shows under first curve (higher) displacement of solvent alone through the core and under second curve (lower) displacement of solvent with 10% wt PLA through the core. PLA is acting as fluid loss agent for non aqueous solvent and is able at higher concentration to totally stop non aqueous solvent circulation.

What is claimed is:

1. A method comprising introducing into a well a non-aqueous based fluid comprising a degradable material stabilized therein.

2. The method of claim 1, wherein the well is a wellbore intersecting a subterranean formation.

3. The method of claim 1, wherein the fluid further comprises water.

4. The method of claim 3, wherein the fluid is an emulsion.

5. The method of claim 3, wherein the fluid is a water in oil emulsion.

6. The method of claim 3, wherein the fluid is an acid in oil emulsion.

7. The method of claim 1, further comprising a salt.

8. The method of claim 1, wherein the degradable material comprises at least one of lactide, glycolide, polylactic acid, polyglycolic acid, copolymers of polylactic acid and polyglycolic acid, copolymers of glycolic acid with other hydroxy-, carboxylic acid-, or hydroxycarboxylic acid-containing moieties, copolymers of lactic acid with other hydroxy-, carboxylic acid-, or hydroxycarboxylic acid-containing moieties, or mixtures thereof.

9. The method of claim 1, wherein the degradable material is hydrolyzed over a period of time.

10. The method of claim 1, wherein the fluid comprises an organic solvent.

11. The method of claim 10, wherein the organic solvent is selected from the group consisting of diesel oil, kerosene, paraffinic oil, crude oil, LPG, toluene, xylene, ether, ester, mineral oil, biodiesel, vegetable oil, animal oil, and mixtures thereof.

12. The method of claim 1, further comprising at least one step selected from the group consisting of: acidizing the formation, fracturing the formation, gravel packing the formation, drilling the formation, and cleaning-up the wellbore.

13. The method of claim 1, further comprising treating the subterranean formation.

14. The method of claim 13, wherein the treating is selected from the group consisting of: well killing operation, loss circulation, fracturing, acidizing, matrix stimulation, zonal isolation, plugging the well, sand control, and cleaning the wellbore.

15. A method to reduce fluid loss, comprising:
introducing in a wellbore intersecting a subterranean formation a degradable material stabilized in a non-aqueous based fluid,
contacting the material with the formation, and
reducing fluid loss into the formation.

16. The method of claim 15, wherein the degradable material comprises at least one of lactide, glycolide, polylactic acid, polyglycolic acid, copolymers of polylactic acid and polyglycolic acid, copolymers of glycolic acid with other hydroxy-, carboxylic acid-, or hydroxycarboxylic acid-containing moieties, copolymers of lactic acid with other hydroxy-, carboxylic acid-, or hydroxycarboxylic acid-containing moieties, or mixtures thereof.

17. The method of claim 15, wherein the fluid comprises an organic solvent.

18. The method of claim 17, wherein the organic solvent is selected from the group consisting of diesel oil, kerosene, paraffinic oil, crude oil, LPG, toluene, xylene, ether, ester, mineral oil, biodiesel, vegetable oil, animal oil, and mixtures thereof.

19. The method of claim 15, wherein the fluid further comprises water.

20. The method of claim 15, wherein the fluid further comprises a salt.

21. A method comprising introducing into a well a stabilized emulsion of a non-aqueous based fluid with a degradable material.

22. The method of claim 15, wherein the degradable material comprises at least one of lactide, glycolide, polylactic acid, polyglycolic acid, copolymers of polylactic acid and polyglycolic acid, copolymers of glycolic acid with other hydroxy-, carboxylic acid-, or hydroxycarboxylic acid-containing moieties, copolymers of lactic acid with other hydroxy-, carboxylic acid-, or hydroxycarboxylic acid-containing moieties, or mixtures thereof.

23. The method of claim 15, wherein the non-aqueous based fluid comprises an organic solvent.

24. The method of claim 23, wherein the organic solvent is selected from the group consisting of diesel oil, kerosene, paraffinic oil, crude oil, LPG, toluene, xylene, ether, ester, mineral oil, biodiesel, vegetable oil, animal oil, and mixtures thereof.
